(19) United States
(12) Patent Application Publication
(10) Pub. No.: US 2014/0282913 A1
(43) Pub. Date: Sep. 18, 2014

(54) PROCESS FOR CAPTURING, STORING, AND ACCESSING A PERSONAL LEGACY IN A DIGITAL MULTIMEDIA DATA STORAGE SYSTEM

(71) Applicant: NATHANIEL VIGIL, Spanaway, WA (US)

(72) Inventor: NATHANIEL VIGIL, Spanaway, WA (US)

(21) Appl. No.: 14/211,843

(22) Filed: Mar. 14, 2014

Related U.S. Application Data
(60) Provisional application No. 61/798,214, filed on Mar. 15, 2013.

(51) Int. Cl. G06F 21/31; G06F 17/30

(52) U.S. Cl. CPC G06F 21/31; G06F 17/30017; G06F 17/30861
USPC 726/4

(57) ABSTRACT

Some embodiments of the invention include a novel digital multimedia data storage system to store personal legacies of individuals which include stories, life experiences, memories, videos, audio clips, pictures, advice (in text and in audio/video form), and other such items associated with the individual's life. Some embodiments of the invention keep a digital journal of the individual that can be accessed by future generations. Some embodiments of the invention include a novel process for saving the personal legacy of the individual in the digital multimedia data storage system as a way for the individual to leave a legacy that is not limited to memory but is accessible for future generations to review.

### CLAIM OF BENEFIT TO PRIOR APPLICATION

This application claims benefit to U.S. Provisional Patent Application 61/798,214, entitled “A business and web site design to store peoples stories, life experiences, memories, videos, pictures, advice, in written text and in audio/video form along with keeping a digital journal of oneself that can be accessed by future generations and being password and account protected only the clients chosen people with proper password can access. A way to leave a legacy of oneself not limited to memory but accessible for future.,” filed Mar. 15, 2013. The U.S. Provisional Patent Application 61/798,214 is incorporated herein by reference.

### BACKGROUND

Embodiments of the invention described in this specification relate generally to systems and processes for recording and storing text, image, video, and audio content, and more particularly, to capturing and storing text, images, videos, and audio clips of a person's legacy.

During life, people are typically able to share their experiences and stories about life with their children and other people they love. However, when people die or become physically limited, they normally do not have opportunities to continue educating their children or loved ones.

Some people record audio/video messages and content onto machine-readable media formats, such as DVDs, CDs, etc. However, DVDs, CDs, and other such readable media tend to get lost or destroyed with time. Backups are often no panacea, as computers crash or data gets lost and/or corrupted. Many people believe it would be a great idea to be able to pass on a personal legacy with a large (or even complete) corpus of media content based on their video recordings, audio clips, writings, art work productions, etc. Nevertheless, people do not really think about how to pass on a legacy over their life experience through the videos, audio clips, writings, and other recordings that they have amassed or prepared during life until it is too late. For instance, their media content may be spread out over many different media, making it hard to centrally locate all such media, or the content simply gets lost, corrupted or destroyed over time.

Therefore, what is needed is a way to store an individual's personal content corpus in a way that pulls together all of content formats, including video, audio, images, writing, art works, etc., in accessible data formats for family, friends, and others to enjoy long after the person dies.

### BRIEF DESCRIPTION

Some embodiments of the invention include a novel digital multimedia data storage system and a novel process for storing a personal legacy of an individual in the digital multimedia data storage system.

In some embodiments, the digital multimedia data storage system stores a set of digital multimedia content items associated with the individual for other people to access. In some embodiments, the digital multimedia data storage system includes a set of security permissions that restrict access to the digital multimedia content items by the other people.

In some embodiments, the process for storing a personal legacy of an individual in the digital multimedia data storage system comprises capturing a set of digital multimedia content items, creating an organizational structure in the storage system based on the captured set of content items, and storing the captured set of content items within the organizational structure of the storage system. In some embodiments, the process further comprises receiving a set of access credentials to view the personal legacy of the individual and allowing access to the personal legacy based on the received set of access credentials.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a digital multimedia data storage system of some embodiments.

FIG. 2 conceptually illustrates a process for accessing an individual's personal legacy in some embodiments.

FIG. 3 conceptually illustrates a process for capturing a personal legacy in some embodiments.

FIG. 4 conceptually illustrates a process for storing a personal legacy in some embodiments.

FIG. 5 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel digital multimedia data storage system and a novel process for storing a personal legacy of an individual in the digital multimedia data storage system. In some embodiments, the digital multimedia data storage system stores a set of digital multimedia content items associated with the individual for other people to access. In some embodiments, the digital multimedia data storage system includes a set of security permissions that restrict access to the digital multimedia content items by the other people.

By way of example, FIG. 1 conceptually illustrates a digital multimedia data storage system 10 of some embodiments. As shown in this figure, a person is able to create their own organizational structure in the storage system 10 in order to prepare their own legacy. In doing so, the person would upload video, audio, text, graphic and photo-realistic images, holographic imagery, animations, software, and other such files that the person might include as part of their legacy, or as part of the legacy the person wishes to share with friends, family members, and others who are granted permission to access some or all of the files uploaded into the system and laid out according to the custom-prepared organizational structure. In this way, the person would be functioning as his or her own historical archive manager. As a data storage repository for the person's legacy, the storage system 10 can be linked to other storage repositories of other people. For instance, the person may have children and link the site to the legacy sites that have been prepared for the children.

In this way, when people pass or become unable to communicate in a routine manner, they may be able to continue educating their children or loved ones through the legacy historical archive which the digital multimedia data storage system 10 is capable of doing. In essence, the storage system 10 leaves a digital persona of the person, such that after the person passes on, any information that was recorded and saved about their ideas, experiences, opinions, etc., in advance of passing on, will be available to select others. Then, those select people who are left behind get to access this information and get to see and hear their lost loved ones, or they get to read and listen to their stories and advice, and so on.

The embodiments described in this specification differ from and improve upon currently existing options. In particular, people today if they are inclined can leave these videos behind stored somewhere, recording and storing them on DVDs, CDs, memory sticks, or on their computer. However, people move, people forget where they leave things, and children tend to destroy important things by accident. Since these devices and media get destroyed or lost, the digital multimedia data storage system allows them to share their legacy with others, regardless of the state or location of their physical belongings, devices, and/or media.

In addition, a lot of people do not know where to start in terms of building their own legacy and historical record/archive. In some embodiments, the digital multimedia data storage system includes a set of processes which step users through preparing a legacy and capturing/storing the files and content media needed to flesh out their legacy. For instance, in some embodiments, a process includes storing all of the file-based multimedia data in a person's custom-prepared organizational structure within the digital multimedia data storage system. In some embodiments, the process provides one or more templates for a person to use in preparing a legacy plan and organizational structure. In some embodiments, the process includes a set of steps to assist a person in developing their own ideas and thinking of new ideas for sharing aspects of the person's life with others. In this way, the processes show users how they can capture their own ideas in a digital format (e.g., audio, videos, animations, photos, holographic imagery, etc.) and the importance of making these legacy data files. Furthermore, the system includes maintenance processes such as data storage back up and file integrity operations performed routinely, as well as including the ability to scale for high data needs and performance requirements and grown as new technology surfaces. The system makes it easy for people to leave themselves behind and for families, friends, couples to grow with each other and have a private forum just for them.

In some embodiments, the process for storing a personal legacy of an individual in the digital multimedia data storage system comprises capturing a set of digital multimedia content items, creating an organizational structure in the storage system based on the captured set of content items, and storing the captured set of content items within the organizational structure of the storage system. In some embodiments, the process further comprises receiving a set of access credentials to view the personal legacy of the individual and allowing access to the personal legacy based on the received set of access credentials.

The digital multimedia data storage system of the present disclosure may perform one or more of the following processes. This list of possible constituent processes is intended to be exemplary only and it is not intended that this list be used to limit the digital multimedia data storage system of the present application to just these processes. Persons having ordinary skill in the art relevant to the present disclosure may understand there to be equivalent processes that may be substituted within the present disclosure without changing the essential function or operation of the digital multimedia data storage system.

1. A process for accessing another individual's personal legacy in the digital multimedia data storage system;

2. A process for capturing an individual's personal legacy, including the digital content files needed to allow others to easily access the individual's personal legacy;

3. A process for storing the individual's personal legacy in the digital multimedia data storage system.

The various processes of the digital multimedia data storage system of the present disclosure as presented in the figures and in this Specification may be related in the following exemplary fashion. It is not intended to limit the scope or nature of the relationships between the various processes and the following examples are presented as illustrative examples only. In particular, each of the processes are implemented in at least one embodiment as software which operates on a computing device. In some embodiments, the software includes a web server software application operating on a web server physical computing device. In some embodiments, the web server provides access to and data communication with respect to at least one website. In some embodiments, an additional server that is communicably connected to the web server is able to store digital multimedia data related to a person's legacy. In some embodiments, the system further includes a backup storage unit. The backup storage can be directly connected to the web server or the other server, or in some embodiments, to a separate computer. The computing devices and servers are connected over a network, such as the Internet. Each computing device and server also includes the necessary computer software protections, along with physical and virtual security. The backup generators kick in when power goes out, with servers in different places storing and backing up data this insures people will not lose what they made.

By way of example, FIG. 2 conceptually illustrates a process 20 for accessing an individual's personal legacy in some embodiments. As shown in this figure, anyone who attempts to access the person's legacy starts by accessing a designated website. The website will have a set of users who are allowed to access the legacy of the person on the website. Each user will have a set of access permissions which they must enter prior to accessing the person's legacy multimedia files. In some embodiments, the permissions are individually tailored for different people to access different parts of the legacy. For instance, a person's children may be granted access to all videos from their childhood years, friends may be able to access all social media posted files, and the person's spouse may be granted private access to legal documents such as a marriage certificate, a will, tax documents, ownership documents, health documents, etc.

In FIG. 3, which conceptually illustrates a process 30 for capturing a personal legacy in some embodiments, the figure includes several steps in which a person (i.e., a “client” using the software to create legacy) creates a profile, links to one or more social media sites and creates associated groups with co-workers, family members, old college friends, friends in a fantasy pool, etc. Almost any kind of group can be created using features of the system during profile creation. In some embodiments, the client would then capture some multimedia files to be used as part of the legacy. The client can then post (i.e., upload and save) the media data to allow other selected users to view immediately. As time goes on, the client can invite other people to access the legacy site so that hopefully by the time the person is no longer able to work with the site (i.e., when the person dies or becomes physically incapacitated), they will have invited all of their friends and relations to access the legacy site.

The digital multimedia data storage system of the present disclosure generally works in a way that provides a chance for a person to teach anyone (i.e., their kids, friends, co-workers, etc.) lessons about life after you are gone. Even if the person lives to an old age, heirs and friends will be able to look the person up and listen to what the person has to say on a variety of topics or what the person may have wrote about a topic. They can see what the person thought and what the person looked like when the person was, for example, 25, 30, 45, 65, and above. The person who creates the historical archive of their legacy on the system will also be able to go back and see how they may have changed throughout the years. The person will be able to edit their videos and change them as desired or make more and add onto them. A person using the digital multimedia data storage system is insuring that his or her loved ones will be able to access the videos/writings after dying.

The system of some embodiments assists users in making their own digital media content files to include in their own legacy package. For instance, the system includes one or more software tools which assist users in making videos, leaving writings, uploading videos and audio clips for others to access and review. In some embodiments, the system includes one or more guides to assist users. For example, when a person makes videos there may be a guide on various subjects to help record, capture, upload, and store the video clips. The subjects cover anything in life.

In some embodiments, the system is scalable to allow each user who creates a legacy site to be able to go into depth on subjects or give general information on other subjects. The system includes such flexibility so that users are able to tailor the level of information and the type of wisdom to leave for loved ones if the unthinkable happens and when the inevitable happens.

In some embodiments, a process for establishing a legacy includes selecting a legacy package to start with. Once a user decides on which package to start with, the process allocated a designated amount of digital site resources. In some embodiments, the digital site resources comprise an allocated amount of run-time memory, an allocated amount of persistent storage memory, one or more sets of digital site tools, and one or more management features. In this way, the person can start making or downloading videos for your loved ones.

As an example of a process for making a video, in some embodiments, a person can make these videos as noted above. The person may include a title page as usual with an options tab available. The video editor maker may be on the right in a package that comes with an installed set of preconfigured video tools. In some embodiments, the person can click on it enlarge and record from their computer if they wish. Below the video editor option may be a download a video option where the client can download their video to the page. The title of the download shows up after download complete and they can rename the video drag and drop the video into the category folders. The title of their video can be changed along with going back and editing the video they are making.

In some embodiments, the person has the capability in the system (i.e., under the download a video option tab) to start a video journal. In some embodiments, the system will always allow a client to have the option of starting a daily journal. In some embodiments, the daily journal is on a different data storage site that is separate from the legacy site. Separate sign-in may be required in some embodiments.

FIG. 4 conceptually illustrates a process for storing a personal legacy in some embodiments. As shown in this example, a person who creates a legacy site is able to create and provide access to a video journal. Also, in this example, the client is able to upload media content files including holographic images, audio clips, text documents, software as necessary, and other such content data files. Journals can then be shared, can be made interactive (i.e., where others can amend/edit/comment, etc.). In some embodiments, journals can be shared live or archived. In this way, active real-time journals can be posted for all invited guests to review.

To make the digital multimedia data storage system of the present disclosure, a website design would be implemented for the web server to host. People can make different websites that do the same thing and title it different. Some embodiments of the system may include a very specific voice command recognition software. Hologram technology is implemented in some embodiments via software operating on standard computing devices while in other embodiments, hardware accelerators are used. There also may be recognition software in some embodiments and able to respond to a person's facial expressions. Data storage is getting physically smaller and holding more for cheaper.

The examples described above by reference to FIGS. 1-4 illustrate that any person can begin or continue to build a personal legacy in a manner that allows family members, friends, and others to review various items that a person finds valuable or important to share. While everyone can be sure that a day will come when they die, a personal legacy can be valuable at any stage in life because life is not predictable and maintaining a variety of items to pass on to future generations is organizationally challenging. For example, people move, people forget where they leave things, children tend to destroy important things by accident, and other such events in life occur which make embodiments the digital multimedia data storage system a priceless tool for any individual to build and maintain a personal legacy that will last well beyond the individual's own living years. As was explained, the digital multimedia data storage system of some embodiments can store all of the data for an individual's personal legacy, including video, audio, text, images, holographs, advice, etc. Also, at least some embodiments include templates and ideas that assist individuals in preparing, creating, and adding to their personal legacies.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

FIG. 5 conceptually illustrates an electronic system 500 with which some embodiments of the invention are implemented. The electronic system 500 may be a computer, phone, PDA, or any other sort of electronic device. Such an electronic system includes various types of computer readable media and interfaces for various other types of computer readable media. Electronic system 500 includes a bus 505, processing unit(s) 510, a system memory 515, a read-only 520, a permanent storage device 525, input devices 530, output devices 535, and a network 540.

The bus 505 collectively represents all system, peripheral, and chipset buses that communicatively connect the numerous internal devices of the electronic system 500. For instance, the bus 505 communicatively connects the processing unit(s) 510 with the read-only 520, the system memory 515, and the permanent storage device 525.

From these various memory units, the processing unit(s) 510 retrieves instructions to execute and data to process in order to execute the processes of the invention. The processing unit(s) may be a single processor or a multi-core processor in different embodiments.

The read-only-memory (ROM) 520 stores static data and instructions that are needed by the processing unit(s) 510 and other modules of the electronic system. The permanent storage device 525, on the other hand, is a read-and-write memory device. This device is a non-volatile memory unit that stores instructions and data even when the electronic system 500 is off. Some embodiments of the invention use a mass-storage device (such as a magnetic or optical disk and its corresponding disk drive) as the permanent storage device 525.

Other embodiments use a removable storage device (such as a floppy disk or a flash drive) as the permanent storage device 525. Like the permanent storage device 525, the system memory 515 is a read-and-write memory device. However, unlike storage device 525, the system memory 515 is a volatile read-and-write memory, such as a random access memory. The system memory 515 stores some of the instructions and data that the processor needs at runtime. In some embodiments, the invention's processes are stored in the system memory 515, the permanent storage device 525, and/or the read-only 520. For example, the various memory units include instructions for processing appearance alterations of displayable characters in accordance with some embodiments. From these various memory units, the processing unit(s) 510 retrieves instructions to execute and data to process in order to execute the processes of some embodiments.

The bus 505 also connects to the input and output devices 530 and 535. The input devices enable the user to communicate information and select commands to the electronic system. The input devices 530 include alphanumeric keyboards and pointing devices (also called “cursor control devices”). The output devices 535 display images generated by the electronic system 500. The output devices 535 include printers and display devices, such as cathode ray tubes (CRT) or liquid crystal displays (LCD). Some embodiments include devices such as a touchscreen that functions as both input and output devices.

Finally, as shown in FIG. 5, bus 505 also couples electronic system 500 to a network 540 through a network adapter (not shown). In this manner, the computer can be a part of a network of computers (such as a local area network (“LAN”), a wide area network (“WAN”), or an intranet), or a network of networks (such as the Internet). Any or all components of electronic system 500 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 2-4 conceptually illustrate processes in which the specific operations of these processes may not be performed in the exact order shown and described. Specific operations may not be performed in one continuous series of operations, and different specific operations may be performed in different embodiments. Furthermore, the processes could be implemented using several sub-processes, or as part of a larger macro process. Thus, one of ordinary skill in the art would understand that the invention is not to be limited by the foregoing illustrative details, but rather is to be defined by the appended claims.

I claim:

1. A digital multimedia data storage system that is used to organize and store a plurality of multimedia content representing a personal legacy of an individual, the digital multimedia data storage system comprising:
a web server computer that is connected to a network and hosts a website from which (i) the individual can organize a database structure for a set of multimedia content files that represent the personal legacy and (ii) a set of authorized people can access the multimedia content files to review the personal legacy of the individual;
a database management system comprising the database and a database management application connected to the web server and interfaced through the website; and
a data security center comprising an authentication application that requires each authorized person to login to the website before accessing the multimedia content files to review the personal legacy.

2. The digital multimedia data storage system of claim 1, wherein the web server computer comprises a journaling application that is accessible to the individual from the website and allows the individual to provide live journals of events during life.

3. The digital multimedia data storage system of claim 2, wherein the database management system automatically captures and archives the live journals.

4. The digital multimedia data storage system of claim 1, wherein the web server computer comprises a social media application that connects to user accounts of the individual for a set of social media websites designated by the individual.

5. The digital multimedia data storage system of claim 4, wherein the social media application captures postings associated with the user account on each designated social media website.

6. The digital multimedia data storage system of claim 5, wherein the database management system automatically archives the captured social media postings.

7. A non-transitory computer readable medium storing a program which when executed by at least one processing unit of a computing device provides a personal legacy of an individual, said program comprising sets of instructions for:
receiving a set of information about the individual;
creating a profile of the individual based on the received set of information;
defining an organizational structure of a personal legacy of the individual in a digital multimedia data storage system;
receiving a set of multimedia content data associated with the individual's personal legacy;
storing the received set of multimedia content data in the organizational structure of the individual's personal legacy; and
designating a set of permissions for a set of people to access the individual's personal legacy.

8. The non-transitory computer readable medium of claim 7, wherein the program further comprises a set of instructions for receiving a journal selection that provides live journal updates of the individual's personal legacy to one or more people in the set of people.

9. The non-transitory computer readable medium of claim 7, wherein the program further comprises sets of instructions for:
receiving a set of credentials to access and review the individual's personal legacy;
determining whether the received set of credentials is consistent with permissions designated for a person in the set of people; and
performing an authentication operation comprising only one of (i) denying review access when the received set of credentials is not consistent with permissions designated for any person in the set of people and (ii) allowing review access when the received set of credentials is consistent with permissions designated for at least one person in the set of people.

10. The non-transitory computer readable medium of claim 7, wherein the set of multimedia content data comprises a least one of a data file formatted for video, a data file formatted for audio, a data file formatted for text, a data file formatted for an image, a data file formatted for an animation, and a data file formatted for holographic imagery.
